(19) United States
(12) Patent Application Publication
(10) Pub. No.: US 2004/0066971 A1
(43) Pub. Date: Apr. 8, 2004

(54) Picture image processing method, processing apparatus and recording medium

(75) Inventors: Hiroki Uwai, Kawasaki-shi (JP); Mayumi Nakayama, Chofu-shi (JP)

Correspondence Address: OLIFF & BERRIDGE, PLC, P.O. BOX 19928, ALEXANDRIA, VA, 22320, US

(73) Assignee: Nikon Corporation, Chiyoda-ku (JP)

(21) Appl. No.: 10/678,233

(22) Filed: Oct. 6, 2003

Related U.S. Application Data
(63) Continuation of application No. 09/971,920, filed on Oct. 9, 2001.
Application No. 09/971,920 is a continuation of application No. 09/534,577, filed on Mar. 27, 2000, now abandoned.
Application No. 09/534,577 is a continuation of application No. 08/972,739, filed on Nov. 18, 1997, now abandoned.

(30) Foreign Application Priority Data
Apr. 11, 1997 (JP) 9-093399

(51) Int. Cl. G06K 9/36

(52) U.S. Cl. 382/232

(57) ABSTRACT

An image processing method and apparatus for compressing an image preserves the characteristics of the original picture image in the post compression picture image. A 4 pixel region (for example) is selected from among the original picture image pixels. The values of the upper left pixel, the upper right pixel, the lower left pixel, and the lower right pixel, e.g., are successively determined. If the pixel value of any one of the selected 4 pixels is determined to be a value representative of a line of a line drawing, then a value for a pixel of the compressed picture image corresponding to the 4 pixel region selected from the original picture image is set to the representative value. If none of the 4 pixels in the selected region have a value representative of a line in a line drawing, the value of the pixel of the compressed picture image is established to be a value corresponding to a region in which there is no line of a line drawing.

### INCORPORATION BY REFERENCE

The disclosure of the following priority application is herein incorporated by reference: Japanese Patent Application No. 09-093399, filed Apr. 11, 1997.

### BACKGROUND OF THE INVENTION

1. Field of Invention The present invention relates to a picture image processing method, picture image processing apparatus, and recording medium encoded with a computer-readable control program for controlling the picture image processing apparatus to compress a first picture image to a second picture image. In particular, the invention relates to a computer-readable control program that causes the image processing apparatus to select a group of a first number of pixels from the first picture image, and set a value of a pixel in the second picture image corresponding to the group of pixels by using the value of a specified pixel from the group of pixels, thereby compressing a first picture image to a second picture image.

2. Description of Related Art

Along with the progress made recently with regard to semiconductor technology, electronic devices such as electronic notebooks and electronic cameras have become more widely used. With these types of electronic devices, and in particular when a so-called touch tablet is provided, if pressure is applied to the touch tablet with a pen or finger, the position of the pen is detected.

With electronic devices that are provided with a touch tablet, line input can be accomplished of written characters or memos by the user. In addition, with the referenced electronic devices, a specified interface is provided, wherein connection is accomplished with a personal computer or other central processing unit that can be separate from or a part of the electronic device on which the touch tablet is mounted. The line information can be transmitted and received via the specified interface for further processing in the computer or other central processing device.

The processor (or controller) is controlled by executable instructions in the form of a program, which processes the picture images obtained from the electronic devices, and generates a display of a list of picture images (e.g., thumbnail images) maintained in the electronic device. When the list of picture images are displayed, with a specified proportion of the actual image being thinned out of the stored picture image data, display is largely accomplished with compressed picture images that are smaller than the actual picture image size.

However, if the pixels are thinned according to conventional image processing methods, and small picture images are generated, then depending upon the type of the original picture image, there is the problem that the characteristics of the original picture image will not remain in the compressed picture image.

For example, assume a line drawing, such as the character “H” which is stored over a display region of 16×16 pixels as shown in FIG. 11(A). As shown in FIG. 12, if the display region of 16×16 pixels is compressed to ¼ of its original size by dividing the image into rectangular regions composed of 4 pixels (shown at A), and then selecting as a representative of each region the pixel in the upper left part of each region (which results in the region of the compressed image shown at B), then the original drawing becomes a picture image such as that shown in FIG. 11(B). As seen in FIG. 11(B), the determination of the characteristics (such as character “H”) of the original picture image from this picture image becomes difficult if not impossible.

### SUMMARY OF THE INVENTION

An object of the present invention is to overcome the above-discussed problem encountered when compressing line images. Therefore according to an embodiment of the present invention, the original picture image data is divided into a plurality of pixel regions, and reference is made to at least 2 pixels from each region to determine the value of a corresponding region in the compressed image. If at least 1 pixel has a specified value representative of a point (or spot) in a line picture, then the corresponding region of the compressed picture image is established to have a value corresponding to the specified value. As a result, the characteristics of the original picture image can be maintained in the compressed picture image.

A picture image processing method according to the invention includes the steps of referring to the pixel values of a second number of pixels comprising 2 or more pixels from among a first number of pixels (the pixel region) selected from the original picture image data. For each of the first number of pixels selected from the first picture image data, if at least one pixel from among the second number of pixels has a specified value, then the value of the pixel (the corresponding pixel region) of a second picture image data corresponding to the first number of pixels is established to have the specified value.

The picture image processing apparatus according to the invention refers to the values of a second number of pixels comprising 2 or more pixels from a first number of pixels for each group (each pixel region) of the first number of pixels selected from a first picture image data. If at least one pixel from among the second number of pixels has a specified value, then the value of the pixel (the corresponding pixel region) of a second picture image data corresponding to the first number of pixels is set equal to the specified value by a processing means.

According to another aspect of the invention, a recording medium is encoded with computer-readable executable instructions that make up a control program. The program refers to the values of a second number of pixels comprising 2 or more pixels from among a first number of pixels for each group of the first number of pixels selected from a first picture image data. When at least one pixel from among the second number of pixels has a specified value, the program sets the value of the second picture image data pixel corresponding to the first number of pixels to be the specified value.

With the picture image processing method according to the present invention, for each group of a first number of pixels (for example 4 pixels) selected from a first picture image data, reference is made to the values of a second number of pixels (for example 3 pixels, or any number of pixels comprising 2 or more pixels from among the group of a first number of pixels). When at least one pixel from among the second number of pixels has a specified value, then the value of the pixel of a second picture image data corresponding to the first number of pixels is established to be (i.e., is assigned) the specified value.

With a picture image processing apparatus according to the present invention, for each group of a first number of pixels selected from a first picture image data, a processor determines the values of the pixels of a second number of pixels comprising 2 or more pixels from among the first number of pixels. When at least one pixel from among the second number of pixels is a specified value, then the value of the pixel of a second (compressed) picture image data corresponding to the first number of pixels is set at the specified value.

The recording medium that is encoded with a program as described above, for each group of a first number of pixels selected from the first picture image data, refers to the values of a second number of pixels comprising 2 or more pixels from among the first number of pixels. When at least one pixel from among the second number of pixels has a specified value, then the program sets the value of a second picture image data pixel corresponding to the first number of pixels to be the specified value and records the specified value.

### BRIEF DESCRIPTION OF THE DRAWINGS

The invention will be described in conjunction with the following drawings in which like reference characters designate like elements, and wherein:

FIG. 1 is a block diagram of a first embodiment of a picture image processing apparatus according to the present invention;

FIG. 2 is a flow chart of the operation of the FIG. 1 embodiment at the time of generating a compressed picture image from a specified picture image;

FIG. 3 schematically shows an example of the corresponding relationship between one region of a first picture image and the pixel value of a corresponding region of a second (compressed) picture image according to the first embodiment of the invention;

FIG. 4 is a schematic drawing which shows an example of a compressed picture image (of the FIG. 11(A) image) produced by the first embodiment of the invention;

FIGS. 5(A) and 5(B) are schematic drawings which show another example of a first (noncompressed) picture image and of its second (compressed) picture image produced by the first embodiment of the invention;

FIGS. 6(A) and 6(B) are schematic drawings which show an example of the detection of a straight line in the vertical direction and in the horizontal direction;

FIG. 7 is a flow chart of the operation of a second embodiment of the invention at the time of generating a compressed picture image from a specified picture image;

FIG. 8 schematically shows an example of a corresponding relationship between one region of a first picture image and the pixel value of a corresponding region of a second (compressed) picture image produced by the second embodiment of the invention;

FIG. 9 is a schematic drawing which shows an example of a compressed picture image produced by the second embodiment of the invention;

FIG. 10 is a schematic drawing which shows another example of a compressed picture image produced by the second embodiment of the invention;

FIGS. 11(A) and 11(B) are schematic drawings which show an example of the compression of a prior art picture image accomplished by means of pixel thinning; and

FIG. 12 schematically shows an example of the corresponding relationship between one region of the original (first) picture image and the post compression pixel value of a corresponding region of a second (compressed) picture image of a prior art picture image accomplished by means of pixel thinning.

### DETAILED DESCRIPTION OF PREFERRED EMBODIMENTS

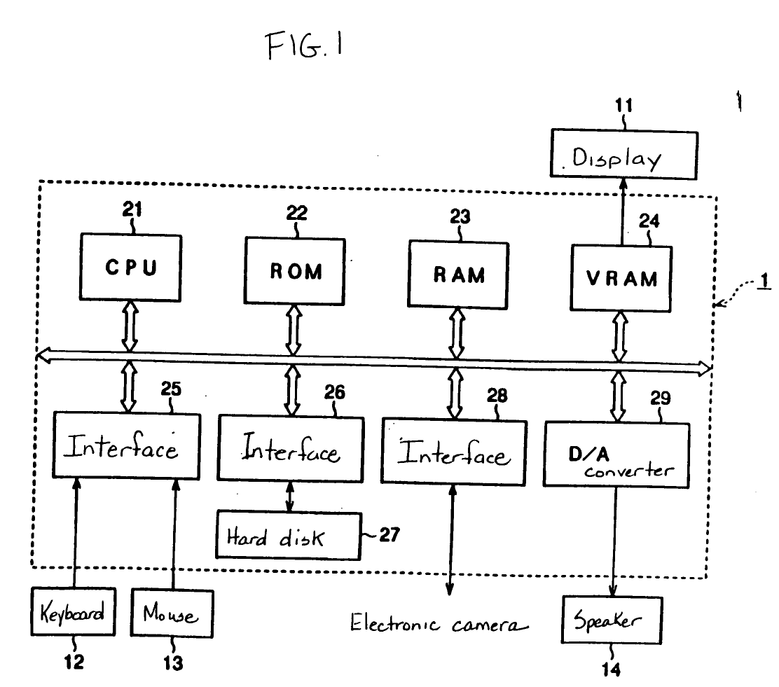

FIG. 1 shows the construction of an embodiment of a picture image processing apparatus according to the present invention. With this picture image processing apparatus 1, the CPU 21 (which functions as processing means) operates according to a program recorded on ROM 22 or on the hard disk 27, in order to accomplish each type of process.

RAM 23 temporarily records the program or data during processing thereof. VRAM 24 is provided with a recording region corresponding to each pixel of a display 11, so that the value of the recording region can be output to the display 11.

The interface 25 is connected to a keyboard 12 and a mouse 13, which are included in order to provide input to the CPU 21.

The interface 26 is connected to the hard disk 27, and is configured so as to accomplish the transmission of a control signal or data between the CPU 21 and the hard disk 27.

The hard disk 27 (recording medium) stores a desired program or data. Alternatives for hard disk 27 include, but are not limited to, a magnetooptical disk, an optical disk, a magnetic disk, a ZIP card or other flash memory cards. An example of a program that can be stored on disk 27 is a program that performs the operations described hereafter.

The interface 28 is connected to an apparatus such as an electronic camera or electronic notebook, for example, that is provided with a compatible interface, and is configured so as to accomplish communications with the apparatus.

The D/A converter 29 converts digital sound data supplied from CPU 21 to analog sound signals, and outputs the analog signals to a speaker 14.

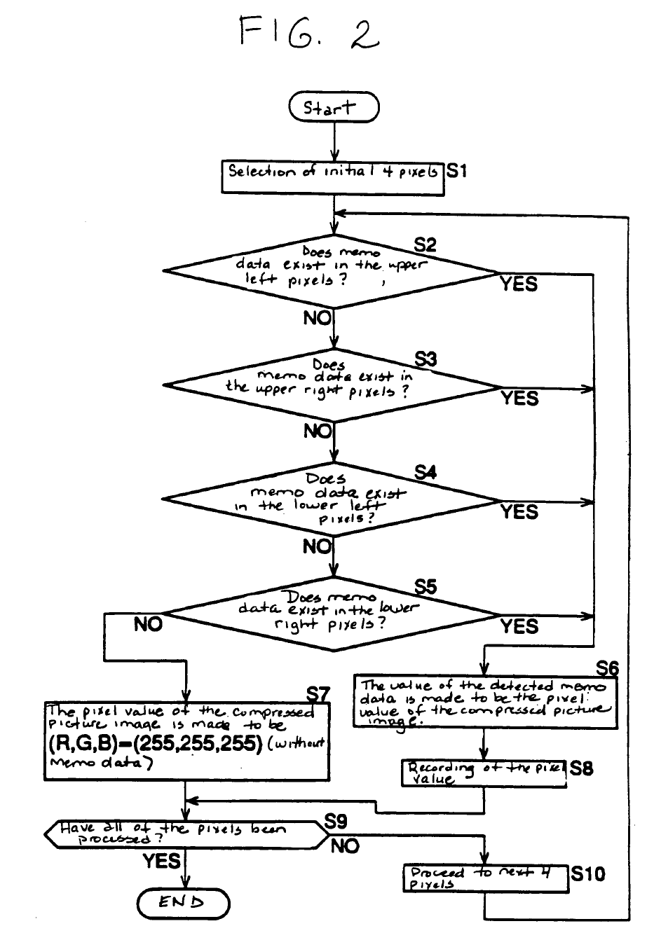

The flow chart of FIG. 2 shows the operation of the FIG. 1 embodiment of the picture image processing apparatus 1 at the time of generating a compressed (second) picture image having ¼ the number of pixels of a specified (first) picture image.

CPU 21 executes the program recorded on the hard disk 27 according to the steps shown in FIG. 2. Initially, with step S1, selection is made of a group of 4 pixels that make up a rectangular region among the picture image data of a number of specified pixels recorded in RAM 23.

Next, in step S2, the CPU 21 determines whether the value of the pixel in an upper left corner of the rectangular region made up of the 4 selected pixels corresponds to a value representative of a line (input) of the line drawing (memo data) making up the picture image data. If it is determined that the value of the upper left pixel is a value representative of a line of the line drawing, then the program proceeds to step S6. On the other hand, if it is determined that the value of the upper left pixel is a value that represents a section of the picture image data in which there is no line (no input) of a line drawing, then the program moves on to step S3.

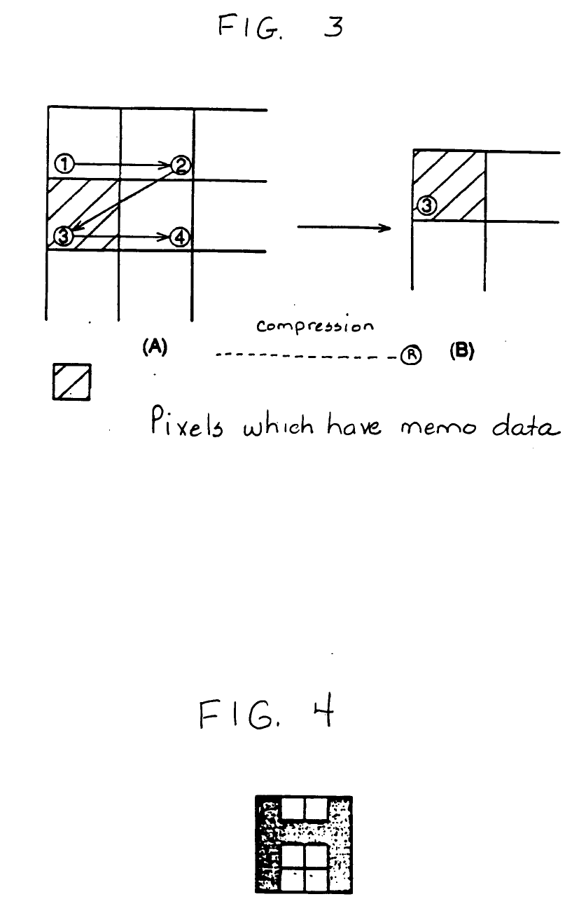

For example, with the 4 pixels shown at (A) in FIG. 3, because the value of the pixel on the upper left (the first pixel checked within the selected region) is not a value that represents a line of a line drawing, the program moves on to step S3.

Also, in step S3, the CPU 21 determines whether or not the value of the pixel on the upper right corner of the rectangular region made up of the 4 selected pixels from the picture image is a value representative of a line of a line drawing. If it is determined that the value of the pixel on the upper right is a value that represents a line of a line drawing, the program moves on to step S6. On the other hand, if it is determined that the value of the upper right pixel is a value that does not represent a line of a line drawing, then the program moves on to step S4.

For example, with the 4 pixels shown at (A) in FIG. 3, because the value of the upper right pixel (the second pixel checked within the selected region) is not a value that represents a line of a line drawing, the program moves on to step S4.

In addition, in step S4, the CPU 21 determines whether or not the value of the pixel to the lower left from among the 4 selected pixels (corresponding to the lower left at the time of displaying the picture image) is a value that represents a line of a line drawing. If the value of the lower left pixel is determined to be a value representative of a line of a line drawing, then the program moves on to step S6. On the other hand, if the value of the lower left pixel is determined to be a value that represents a section of the picture image data in which there is no line of a line drawing, then the program moves on to step S5.

For example, with the 4 pixels shown at (A) in FIG. 3, because the value of the lower left pixel (the third pixel checked within the selected region) is a value that represents a line of a line drawing, the program moves on to step S6.

Furthermore, in step S5, the CPU 21 determines whether the value of the lower right pixel from among the 4 selected pixels (corresponding to the lower right at the time of displaying a picture image) is a value that represents a line of a line drawing. If it is determined that the value of the lower right pixel is a value that represents a line of a line drawing, then the program moves on to step S6. On the other hand, if it is determined that the value of the lower right pixel is a value that represents a section of the picture image data in which there is no line of a line drawing, then the program moves on to step S7.

In steps S2-S5, if it is determined that the value of any of the 4 selected pixels is a value that represents a line of a line drawing, then in step S6, the CPU 21 establishes the value representative of a line to be the value of the pixel of a compressed picture image corresponding to the region of the 4 pixels. This is shown at (B) in FIG. 3. In step S8, the pixel value is recorded in RAM.

On the other hand, when none of the values of any of the selected 4 pixels are values that represent a line of a line drawing, then in step S7, the CPU 21 sets the value corresponding to a region in which there is no line of a line drawing, to a value of the pixel of the compressed picture image corresponding to the region of the 4 pixels.

Subsequently, in step S9, the CPU 21 determines whether the processes of steps S2-S8 have been accomplished relative to all of the pixels. If it is determined that the processes have been accomplished relative to all of the pixels, then the process of the creation of the compressed picture image is completed. If it is determined that there are pixels which have not been processed, then in step S10, following the selection of the next square region composed of 4 pixels, the program returns to step S2, and processing is accomplished relative to those 4 pixels. Also, until all of the pixels are processed, the processing of steps S2-S10 is repeated.

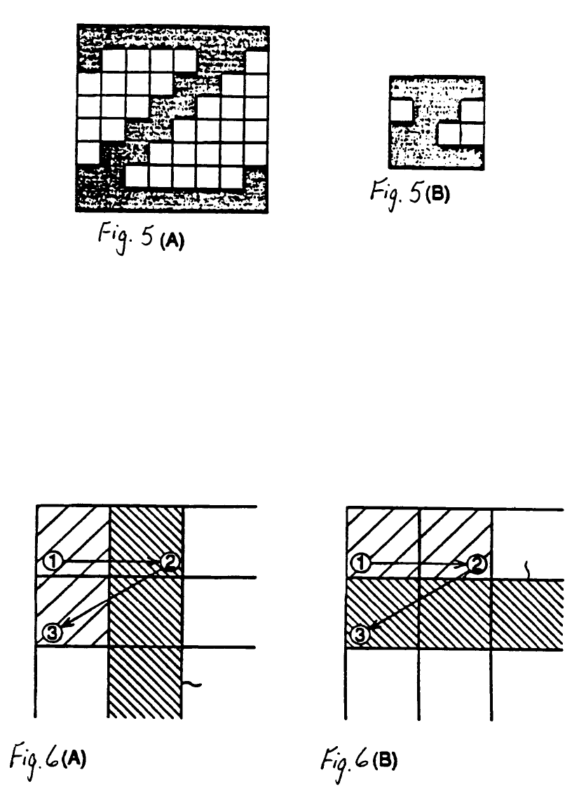

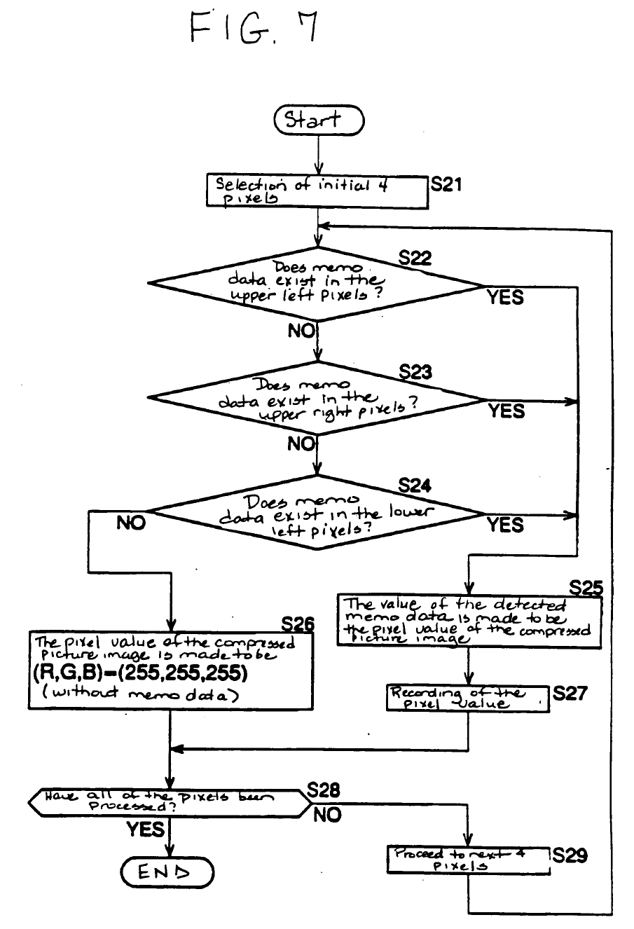

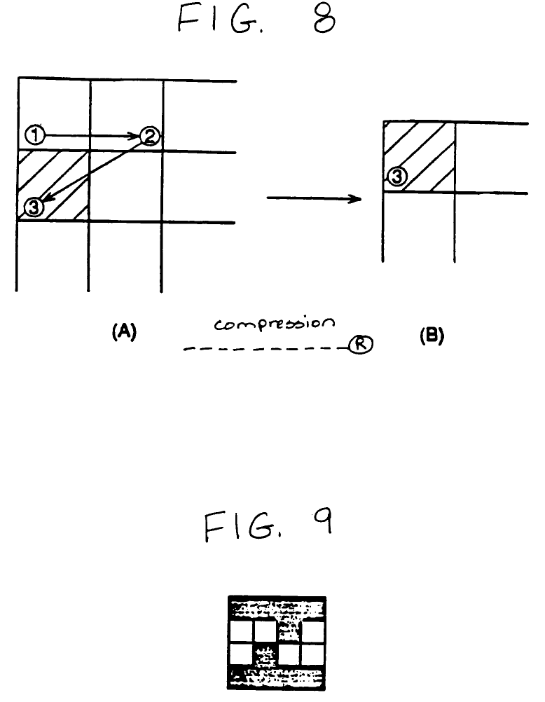

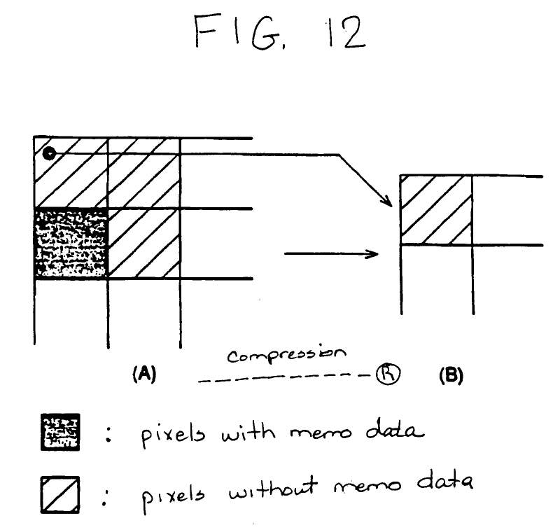

If a compressed picture image is created using the FIG. 2 process, then for example, the characteristics of the picture image original shown in FIG. 11(A) are preserved as shown in FIG. 4.

Furthermore, as indicated above, in a case where reference is made to the 4 pixel values of the region composed by the 4 pixels selected from among the original picture image, then for example the picture image shown in FIG. 5(A) is compressed as shown in FIG. 5(B). In this instance, the proportion of parts of lines in the compressed picture image are slightly increased.

As shown in FIGS. 6(A) and 6(B), a straight line in the vertical direction and a straight line in the horizontal direction can be preserved in the post compression picture image by referring to the value of 3 pixels from among the 4 pixels of the region of the original image. Thus, it is not necessary to check the values of all pixels in each region of the original image. Accordingly, an explanation follows with regard to a second embodiment of the present invention wherein reference is made to the value of 3 pixels from among the 4 pixels selected for each region from the picture image original.

The configuration of the second embodiment is the same as the configuration of the first embodiment (FIG. 1) and only the program used (recorded on a recording medium such as the hard disk 27) differs. Therefore, the explanation of the configuration of the second embodiment is abbreviated, and an explanation is only provided relating to the operations of the second embodiment, with reference to the flow chart of FIG. 7.

CPU 21 executes the program recorded on the hard disk 27 according to the following steps. Initially, in step S21, 4 pixels composing a square region are selected from among the picture image data of a specified number of pixels recorded in RAM 23.

Next, in step S22, the CPU 21 determines whether the value of the pixel on the upper left corner of the selected region of 4 pixels (corresponding to the upper left corner at the time of displaying the picture image) is a value representative of a line of a line drawing (memo data). If it is determined that the value of the upper left pixel is a value representative of a line of a line drawing, then the program moves on to step S25. If it is determined that the value of the pixel from the upper left is a value that represents a section of the picture image in which there is no line of a line drawing, then the program moves on to step S23.

For example, with the 4 pixels shown at (A) in FIG. 8, the value of the upper left pixel is a value which does not correspond to a line of a line drawing. Therefore, the program moves on to step S23.

Also, in step S23, the CPU 21 determines whether the value of the upper right pixel of the selected region of 4 pixels (corresponding to the upper right direction at the time of displaying the picture image) is a value that represents a line of a line drawing. If the value of the upper right pixel is determined to be a value representative of a line of a line drawing, then the program moves on to step S25. On the other hand, if the value of the upper right pixel is determined to be a value that represents a part of the picture image in which there is no line from a line drawing, then the program moves on to step S24.

For example, with the 4 pixels shown at (A) in FIG. 8, because the value of the upper right pixel is not a value that represents a line of a line drawing, the program moves on to step S24.

In addition, in step S24, the CPU 21 determines whether the value of the lower left pixel of the selected region of 4 pixels (corresponding to the lower left direction at the time of displaying the picture image) is a value representative of a line of a line drawing. If it is determined that the value of the lower left pixel is a value that represents a line of a line drawing, then the program moves on to step S25. On the other hand, if the value of the lower left pixel is determined to be a value that represents a part of the picture image in which there is no line of a line drawing, then the program moves on to step S26.

For example, with the 4 pixels shown at (A) in FIG. 8, because the value of the lower left pixel is a value that represents a line of a line drawing, the program moves on the step S25.

Also, in steps S22-S24, if it is determined that the pixel values of any of the upper left, upper right, and lower left pixels from among the selected 4 pixels are values that represent a line of a line drawing, then in step S25, the CPU 21 establishes the value representative of a line to be the value of a compressed picture image pixel corresponding to the region of the 4 pixels. This is shown at (B) in FIG. 8. In step S27, the pixel value is recorded in RAM 23.

On the other hand, in the case where none of the upper left, upper right, and lower left pixels from among the selected 4 pixels have values representative of a line of a line drawing, then in step S26, the CPU 21 establishes the value representative of a region of the picture image in which there is no line of a line drawing to be the value of a compressed picture image pixel corresponding to the region of the 4 pixels.

Next, in step S28, the CPU 21 determines whether the processing of steps S22-S27 has been accomplished relative to all of the pixels. If it is determined that all of the processes relative to the pixels have been accomplished, then the processing of the creation of the compressed picture image is completed. If it is determined that there are pixels which have not yet been processed, then in step S29, following the selection of the next square region composed of 4 pixels, the program returns to step S22, and processing is accomplished relative to those 4 pixels. Also, until all of the pixels have been processed, the processing of steps S22-S29 is repeated.

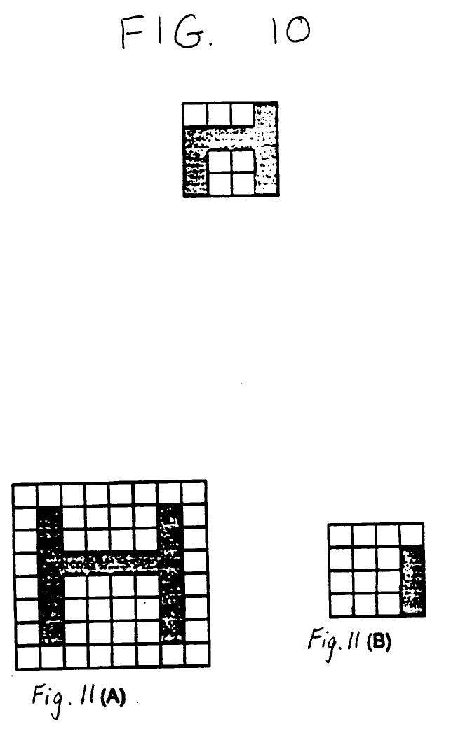

If the compressed picture image is produced in the manner indicated above, then, for example, the characteristics of the original picture image shown in FIG. 5(A) are preserved as shown in FIG. 9. Furthermore, in this manner, if the compressed picture image of the picture image shown in FIG. 11(A) is generated, then it becomes as shown in FIG. 10. The compressed picture image does not provide entire preservation of the characteristics, however, it is better than the picture image of FIG. 11(B).

As described above, reference is made to the values of multiple pixels from among the pixels in a specified region. A pixel value representative of the region is established as a post compression pixel value, thereby preserving the characteristics of the original picture image.

Furthermore, in the preferred embodiment, compression processing is accomplished for groups of 4 pixels. However, processing may also be accomplished for groups of another number of pixel units.

In addition, in the preferred embodiment, reference is made to the pixel values in the order shown in FIG. 3 and FIG. 8. However, reference may be made in another order as well.

The program for executing processes according to the present invention may be recorded on a CD ROM, magnetooptical disk, etc., and distributed to users. The program may be copied to a hard disk and the like, and used. The program also can be obtained over a communications system such as, for example, the Internet (World Wide Web).

As described above, according to the picture image processing method of the present invention and the picture image processing apparatus of the present invention, for each first number of pixels selected from a first picture image data, reference is made to the values of a second number of pixels, which includes 2 or more pixels from among the first number of pixels. When, at a minimum, one of the pixels from among the second number of pixels has a specified value, then a value of a pixel of a second, compressed picture image data corresponding to the first number of pixels is set to the specified value. Therefore, the characteristics of the original picture image can be preserved in the post compression picture image.

According to another embodiment of the present invention, a recording medium is encoded with computer-readable, executable instructions in the form of a control program that first selects a first number of pixels of a first picture image data. The program then refers to the values of a second number of pixels including 2 or more pixels from among the first number of pixels. When, at a minimum, one of the pixels from among the second number of pixels has a specified value, then the value of a pixel of a second compressed picture image data corresponding to the first number of pixels is recorded so as to establish it as the specified value. Therefore, a recording medium according to the present invention can be used in the case where the characteristics of the original picture are preserved in the post compression picture image.

The invention is not limited to implementation by a programmed general purpose computer as shown in the preferred embodiment. For example, the invention can be implemented using one or more special purpose integrated circuit(s) (e.g., ASIC). It will be appreciated by those skilled in the art that the invention can also be implemented using one or more dedicated or programmable integrated or other electronic circuits or devices (e.g., hardwired electronic or logic circuits such as discrete element circuits, or programmable logic devices such as PLDs, PLAs, PALs or the like). In general, any device or assembly of devices on which a finite state machine capable of implementing the flowcharts shown in FIGS. 2 and 7 can be used.

While this invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. A picture image processing method for compressing a first picture image to a second picture image, the method including the steps of:
selecting a group of a first number of pixels from said first picture image;
determining whether at least one of a second number of pixels of said group has a specified value, wherein said second number of pixels includes 2 or more pixels; and
when at least one of said second number of pixels has said specified value, setting a value of a pixel in said second picture image corresponding to said group of pixels equal to a predetermined value.

2. The picture image processing method according to claim 1, wherein said second number of pixels is equal to said first number of pixels.

3. The picture image processing method according to claim 1, wherein said first picture image includes line data.

4. The picture image processing method according to claim 1, wherein said first number of pixels corresponds to a two-dimensional region of said first picture image.

5. The picture image processing method according to claim 4, wherein said step for determining is performed by successively determining the values of pixels arranged in a horizontal direction.

6. The picture image processing method according to claim 4, wherein said step for determining is performed by successively determining the values of pixels arranged in a vertical direction.

7. A picture image processing apparatus for compressing a first picture image to a second picture image, comprising:
means for selecting a group of a first number of pixels from said first picture image;
means for determining whether at least one of a second number of pixels of said group has a specified value, wherein said second number of pixels includes 2 or more pixels from said group of pixels; and
means for setting a value of a pixel in said second picture image corresponding to said group of pixels equal to said specified value when at least one of said second number of pixels is determined to have a predetermined value.

8. The picture image processing apparatus according to claim 7, wherein said second number of pixels is equal to said first number of pixels.

9. The picture image processing apparatus according to claim 7, wherein said first picture image includes line data.

10. The picture image processing apparatus according to claim 7, wherein said first number of pixels corresponds to a two-dimensional region of said first picture image.

11. The picture image processing apparatus according to claim 10, wherein said means for determining successively determines the values of pixels arranged in a horizontal direction.

12. The picture image processing apparatus according to claim 10, wherein said means for determining successively determines the values of pixels arranged in a vertical direction.

13. A picture image processing apparatus for compressing a first picture image to a second picture image, comprising:
a memory; and
a controller coupled to said memory and that uses said memory to compress said first picture image to said second picture image by selecting a group of a first number of pixels from said first picture image, determining whether at least one of a second number of pixels of said group has a specified value, the second number of pixels being 2 or more pixels from said group, and setting a value of a pixel in said second picture image corresponding to said group of pixels equal to said specified value when at least one of said second number of pixels is determined to have a predetermined value.

14. The picture image processing apparatus according to claim 13, wherein said predetermined value is said specified value.

15. The picture image processing apparatus according to claim 13, wherein said controller divides said first picture image into a plurality of said groups and performs said determining and setting steps for each of said plurality of groups.

16. The picture image processing apparatus according to claim 13, wherein said second number of pixels is equal to said first number of pixels.

17. The picture image processing apparatus according to claim 13, wherein said first picture image includes line data.

18. The picture image processing apparatus according to claim 13, wherein said first number of pixels corresponds to a two-dimensional region of said first picture image.

19. The picture image processing apparatus according to claim 18, wherein said controller successively determines the values of pixels arranged in a horizontal direction.

20. The picture image processing apparatus according to claim 18, wherein said controller successively determines the values of pixels arranged in a vertical direction.

21. A recording medium encoded with a computer-readable control program that controls a picture image processing apparatus to compress a first picture image to produce a second picture image by performing the steps of:
selecting a group of a first number of pixels from said first picture image;
determining whether at least one of a second number of pixels of said group has a specified value, wherein said second number of pixels includes 2 or more pixels from said group of pixels; and
when at least one of said second number of pixels has said specified value, setting a value of a pixel in said second picture image corresponding to said group of pixels equal to a predetermined value.

22. The recording medium according to claim 21, wherein said second number of pixels is equal to said first number of pixels.

23. The recording medium according to claim 21, wherein said first picture image includes line data.

24. The recording medium according to claim 21, wherein said first number of pixels corresponds to a two-dimensional region of said first picture image.

25. The recording medium according to claim 24, wherein said step for determining is performed by successively determining the values of pixels arranged in a horizontal direction.

26. The recording medium according to claim 24, wherein said step for determining is performed by successively determining the values of pixels arranged in a vertical direction.
